(19) United States
(12) Patent Application Publication
(10) Pub. No.: US 2017/0286600 A1
(43) Pub. Date: Oct. 5, 2017

(54) Automated Medical Test Data Report, Tracking, and Patient Matching System

(71) Applicants: Muhammad Ali Hasan, Newport Beach, CA (US); David MacLeod, Denver, CO (US); Benjamin F. Williams, Littleton, CO (US)

(72) Inventors: Muhammad Ali Hasan, Newport Beach, CA (US); David MacLeod, Denver, CO (US); Benjamin F. Williams, Littleton, CO (US)

(21) Appl. No.: 15/607,564

(22) Filed: May 29, 2017

Related U.S. Application Data
(60) Provisional application No. 62/314,502, filed on Mar. 29, 2016.

(51) Int. Cl. G06F 19/00; G06Q 50/24

(52) U.S. Cl. CPC G06F 19/322; G06F 19/324; G06Q 50/24; G06F 19/3406; G06Q 50/22

(57) ABSTRACT

An automated medical test data report, tracking, and patient matching system devised to enable secure transmittal of medical test results data over network between a hosting computing apparatus and at least one receiving computing apparatus is provided. Triple tiered security is enabled by action of paired cryptographic keys, sequencing of data by generation of a randomized and securely-shared sequencing order, and fragmentation of data from a data stream into sortable data packets routable to separate and remotely connected partitions by appending a sort code into each data packet collectively prevent compromise of data in transmission over network.

We have invented new and useful improvements in an automated medical test data report, tracking, and patient matching system as described in this specification and that this nonprovisional application claims the benefit of provisional application No. 62314502 filed on Mar. 29, 2016.

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

Medical test data can be extensive. At present, most test data is entered manually by a practitioner on site, or subsequently relayed to a person to manually enter data recorded on a handwritten report. Certain procedures and testing regimens include repetitive tests wherein large volumes of data are generable for monitoring patient health or establishing a baseline. Manual entry and handling of these data is prone to error. What is needed is an automated medical test data report, tracking, and patient matching system that synchronizes medical test data from a test location, or at a testing apparatus itself, with a secure database housing data usable to populate a patient medical record, whereby extensive medical data is automated to populate fields and other graphcial displays by action of conducting the test procedure only and a unique patient account associates relevant data with a particular patient at multiple points of access.

### FIELD OF THE INVENTION

The present invention relates to an automated medical test data report, tracking, and patient matching system devised to enable secure transmission of medical test data generated at a test site (or directly from a testing apparatus) for secure storage and population of a patient medical record. Numerical data is transmitted via secure protocol and associated with a particular, unique patient account. Viewing a patient medical record, then, effects access to the patient account to populate relevant fields and render graphical display of data at the touch of a button.

A synchronization engine manages interfacing of data transmission to update the patient account whereby access to the patient record is rendered up-to-date whenever the record is refreshed, at specific intervals, or when the patient record is accessed. Thus medical test data housed in a plurality of databases, for example, is extractable for population of a single electronic patient medical record.

### SUMMARY OF THE INVENTION

The present automated medical test data report, tracking, and patient matching system has been devised to associate medical test results data with patient identities and thereby enable centralized and decentralized storage and distribution of medical test results among authorized users of a particular patient account. The present automated medical test data report, tracking, and patient matching system enables secure transmissions of data from test sites and test apparatuses to at least one central server whereby an associated patient record is updateable with current test results via secure Internet protocol. Multiple central servers may be connected in network for storage of partitioned data which is subsequently reassembled when viewing a patient medical record over the network. Thus data may be fragmented and partitioned between storages and access points to prevent compromise.

A patient identification data is encoded into data streams transmitted over network, whereby the appropriate patient account is securely updateable and routable between directed locations. The patient identification data may be cryptographically paired with a public and private key, or other secure transfer protocol, whereby identification of the patient is not ascertainable should data be captured between points of presence during data exchange. A sequencing order, devised for positional insertion of data packets into a data stream, may also encode data into data streams whereby extraction of said data is sensible only when the same sequencing order is understood at the receiving location.

A synchronization engine may first intercept data transmission and route the transmission towards an appropriate destination. The synchronization engine may include addition of a temporary sorting tag to the patient identification data. This temporary sorting tag may be usable to route a transmission toward a particular directory or destination. Temporary sorting tags may be constantly changed and randomized by the synchronization engine and added to transmissions uniquely. Once the transmission has been forwarded toward its destination, the synchronization engine may send a temporary sorting tag match code to the destination to associate with the relevant data transmission for appropriate handling. Transmissions are thereby queued at the destination until the equivalent match code is received, whereby the transmission is correctly routed toward its ultimate destination or directory in the appropriate server. Private keys, matchable to the public key encoded in the patient identity data, may thence be used to unlock the patient identity and enter the data into the particular patient's account.

This provides a tiered security system, because interception of the data is meaningless unless it's ultimate destination is known. A third party intercept of a data transmission will only show data absent particular reference points (origin and destination and patient identity, among other particulars) and units, unless the interceptor also managed to capture the sort match code (which is sent separately from the data transmission) and has somehow enabled access to the database as well.

In order to extract the relevant data a third party would also need to intercept the particular sequencing order used to encode the data stream. Since cryptographic keys are used, with private keys not shared over network, the third party would also need to access each central server whereon partitions of data are stored.

Origin of data from a particular testing site or testing apparatus may also include addition of a sort code. This sort code is usable to identify the data origin and may enable determination of how data will be packaged for population into the patient record. For example, a blood test may have a particular sort code associated with it, and the particular test performed may have another sort code, whereby a normalization engine in receipt of the data is enabled determination of how to use the data to populate the patient medical record. Display defaults may likewise be included, whereby the data is displayed graphically by default at a particular interval or relative a particular metric.

A medical test, therefore, transmits results data to update a patient account automatically. The synchronization engine further maintains association of the medical test data and particular patient account, whereby any instance wherein the particular patient account is being viewed, transferred, or in-use by a qualified user, is simultaneously updated at point of access.

Opening a particular user account, therefore, by a qualified user ensures that the most up-to-date version of the user account is accessed and all relevant medical test data is updated by communication with the synchronization engine. Patient accounts are determinable by unique account identification protocol, for example by assignment and maintenance of unique patient account numbers, or other unique identification data.

When a patient account is opened by an end user operating a remote terminal (a desktop computer or peripheral device, for example), the account is accessed at the synchronization engine and data is transferred securely to the end user. Storage of local copies of the account may or may not be enabled except by qualified users. In most instances, an end user may access the patient account by communication protocol with the synchronization engine operating in concert with a secure server wherein data storage may be properly effected in a patient database. Patient medical records are thus preserved in confidence.

At the onset of a medical test, a patient account number, or other patient identification data, is entered at the test location—and may be effected directly into testing apparatuses, as case may be, or may be generated relative the patient's unique biometric data (blood type, finger prints, DNA, or other unique patient identification data, for example). Henceforward, the test result will be paired with the patient account number, or other patient identification data, as case may be, to ensure association with a unique individual.

Test results data may further include test meta data (data as to the particular test conducted), location data, date and time data, and may include personnel data indicative of which practitioners effected the test procedure, whereby the patient medical record is updateable to include relevant meta data as well as the actual results data. Fields within the patient medical record are thus updateable and data is merged appropriately for review by an end user when the medical record is accessed by patient account. Data may be displayed graphically at the touch of a button.

Thus has been broadly outlined the more important features of the present automated medical test data report, tracking, and patient matching system so that the detailed description thereof that follows may be better understood and in order that the present contribution to the art may be better appreciated.

For better understanding of the automated medical test data report, tracking, and patient matching system, its operating advantages and specific objects attained by its uses, refer to the accompanying drawings and description.

### BRIEF DESCRIPTION OF THE DRAWINGS

### Figures

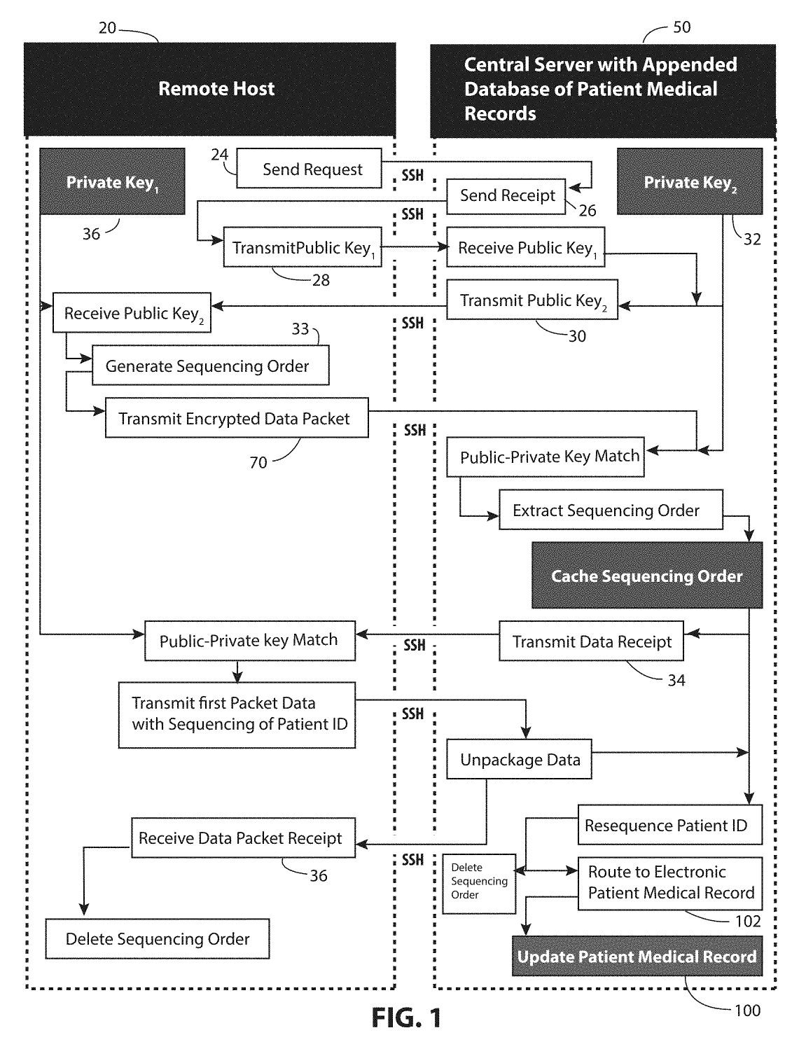

FIG. 1 is a simplified diagrammatic view of an example embodiment of data being processed and exchanged in the present automated medical test data report and tracking system between a single remote host and a central server.

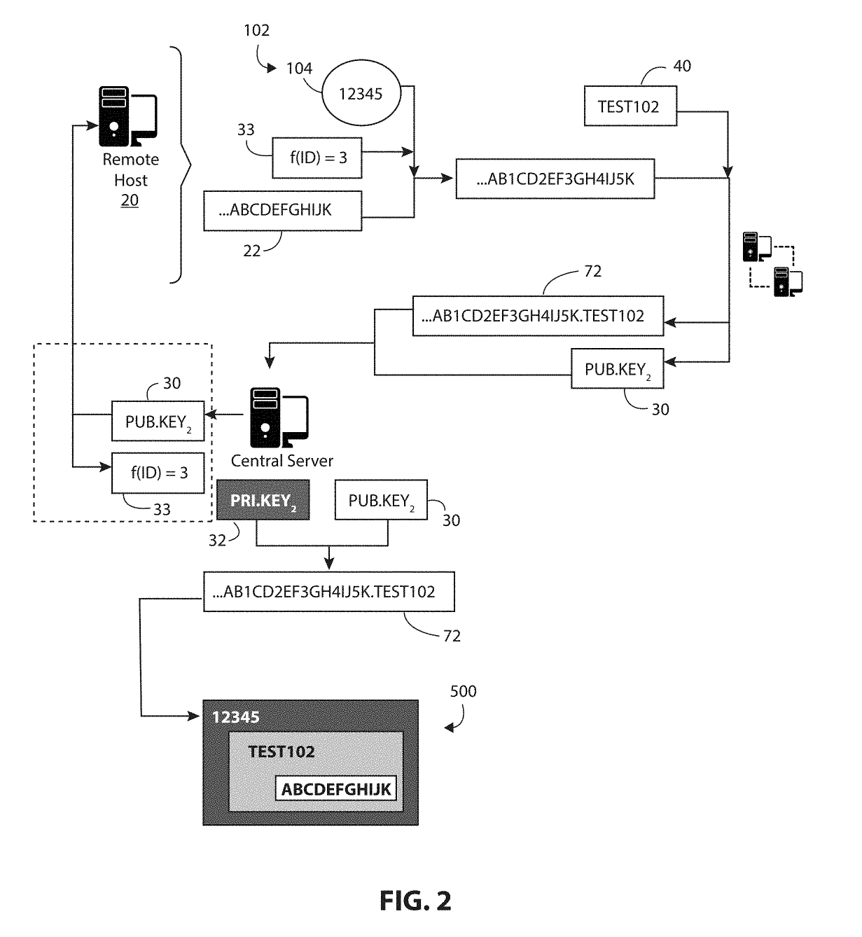

FIG. 2 is a simplified diagrammatic view of an example embodiment of the present system illustrating encoding a data packet with a patient account number by reference to a particular sequencing order for delivery to a central server connected with a remote host over secure network.

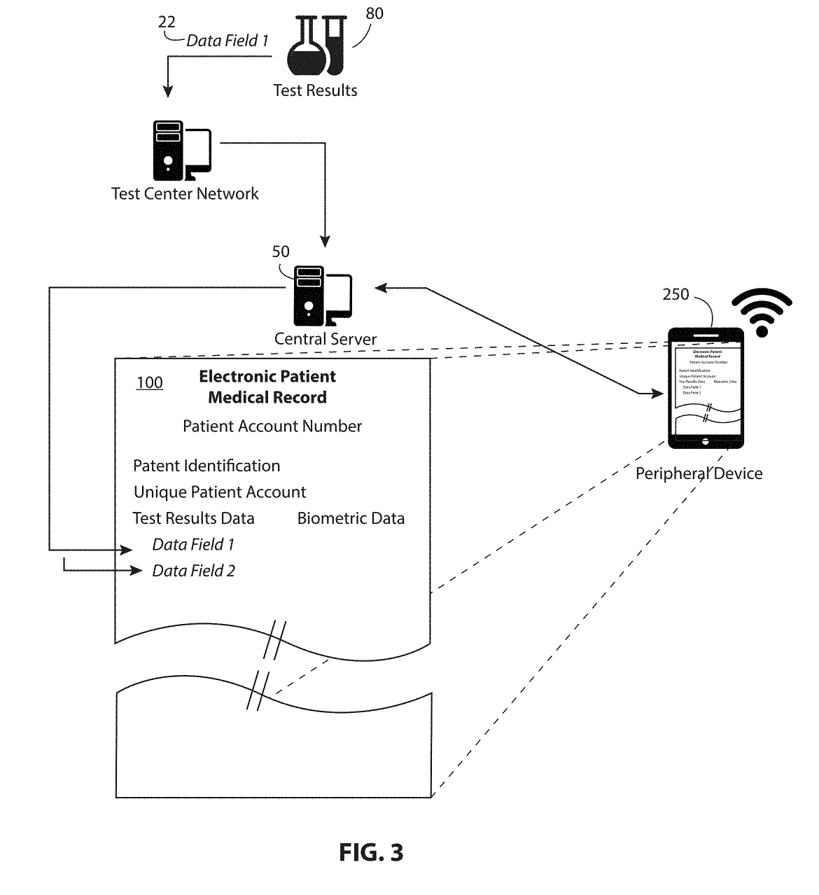

FIG. 3 is a simplified diagrammatic view of an example embodiment of the present system illustrating retrieval of an electronic patient medical record over network for temporary display upon a peripheral device.

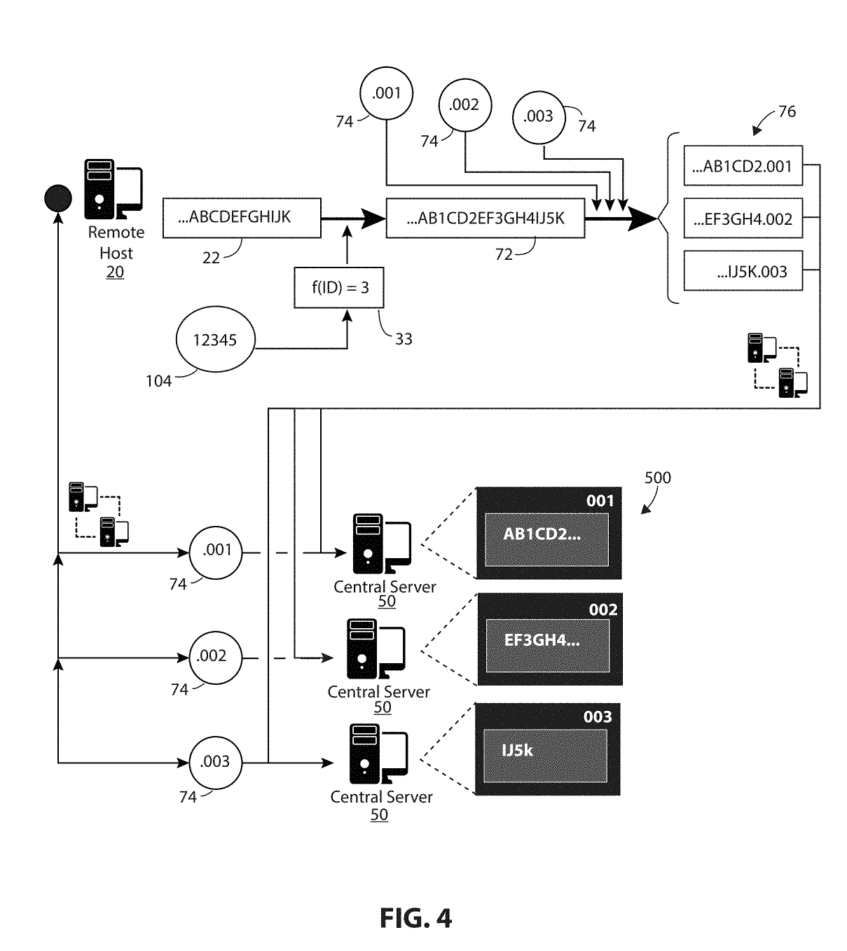

FIG. 4 is a simplified diagrammatic view of fragmenting a merged data stream into fragmented packets by insertion of a sort code whereby said fragmented packets are deliverable to specific directories hosted between a plurality of central servers.

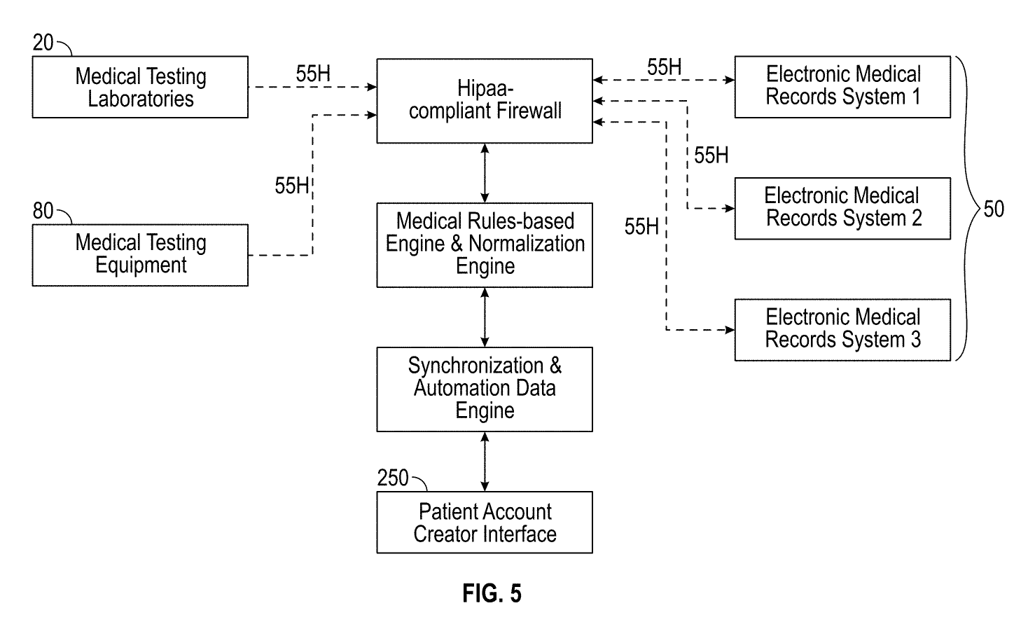

FIG. 5 is a simplified view of an example embodiment of a network of central servers wherefrom data transmission is coordinated between a point of test procedure and a remote host and a peripheral device used to access an electronic patient medical stored in fragments upon each of the central servers and associated with a patient identity.

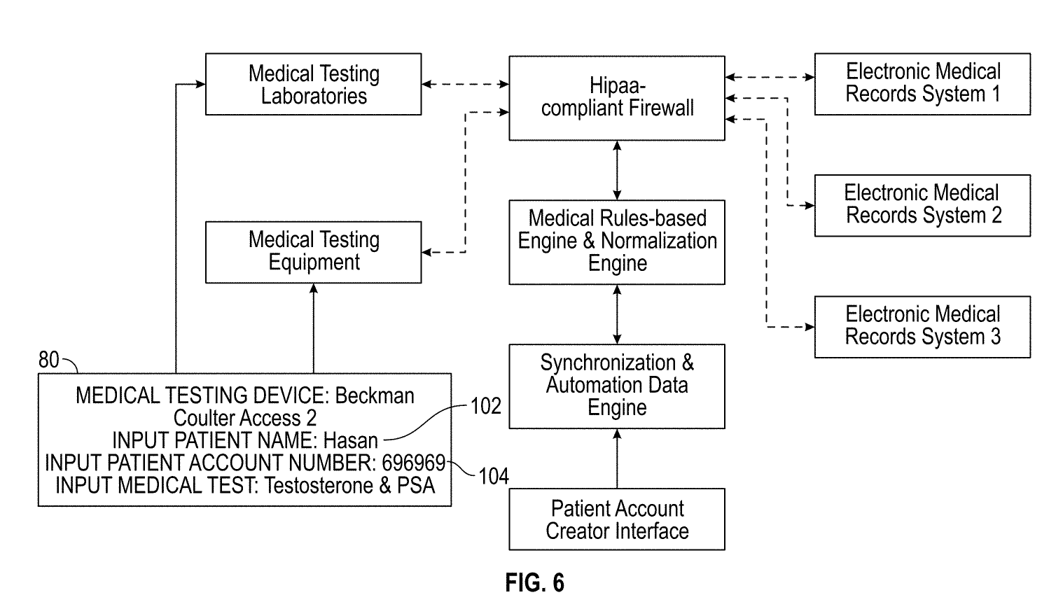

FIG. 6 is a simplified diagrammatic view of an example embodiment of a test results data being uploaded to the network for storage between a plurality of central servers connected over network.

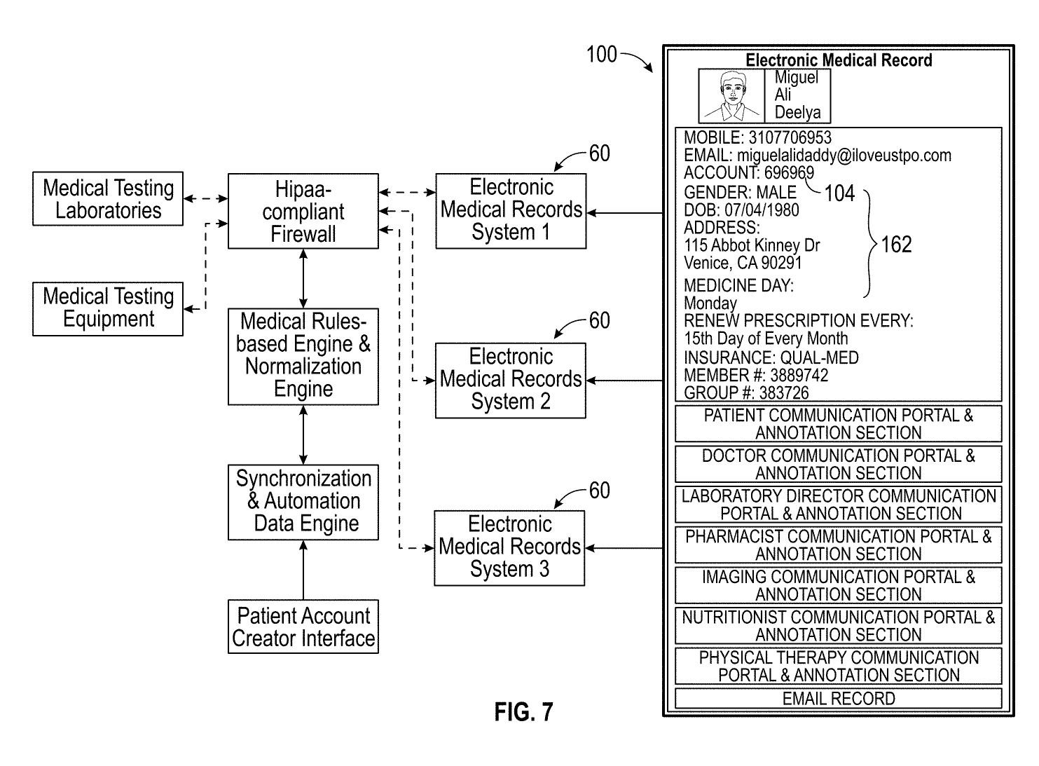

FIG. 7 is a simplified diagrammatic view of an example embodiment of repopulation of an electronic patient medical record displayable upon a peripheral device accessing the network, by action of the synchronization engine between medical databases stored upon a plurality of central servers.

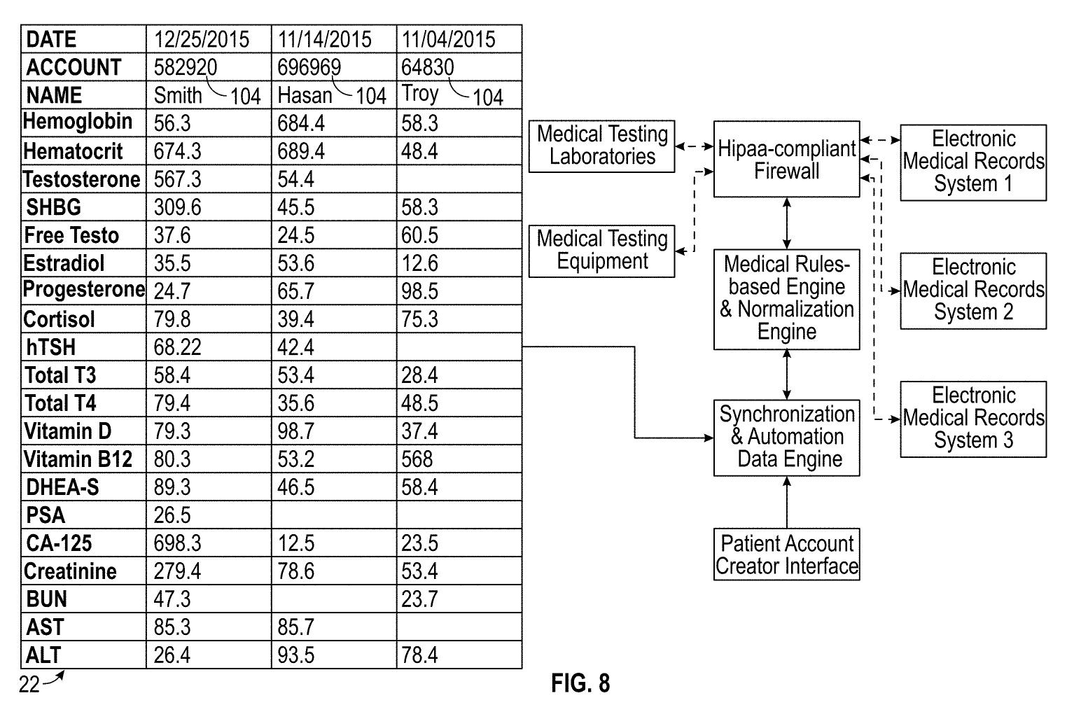

FIG. 8 is a simplified diagrammatic view of an example embodiment of data pertaining to a plurality of electronic patient medical records being coordinated through a synchronization and automation data engine.

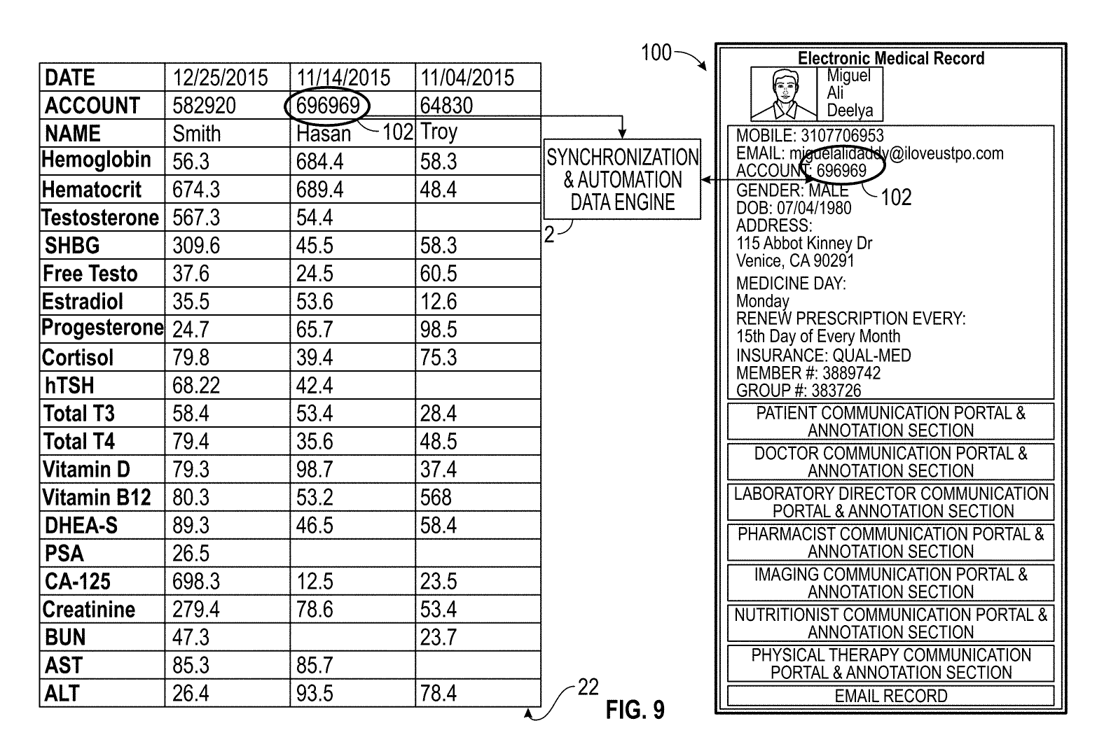

FIG. 9 is a simplified diagrammatic representation of synchronization of a data stream by patient account number to route test results for display associated with a particular electronic patient medical record.

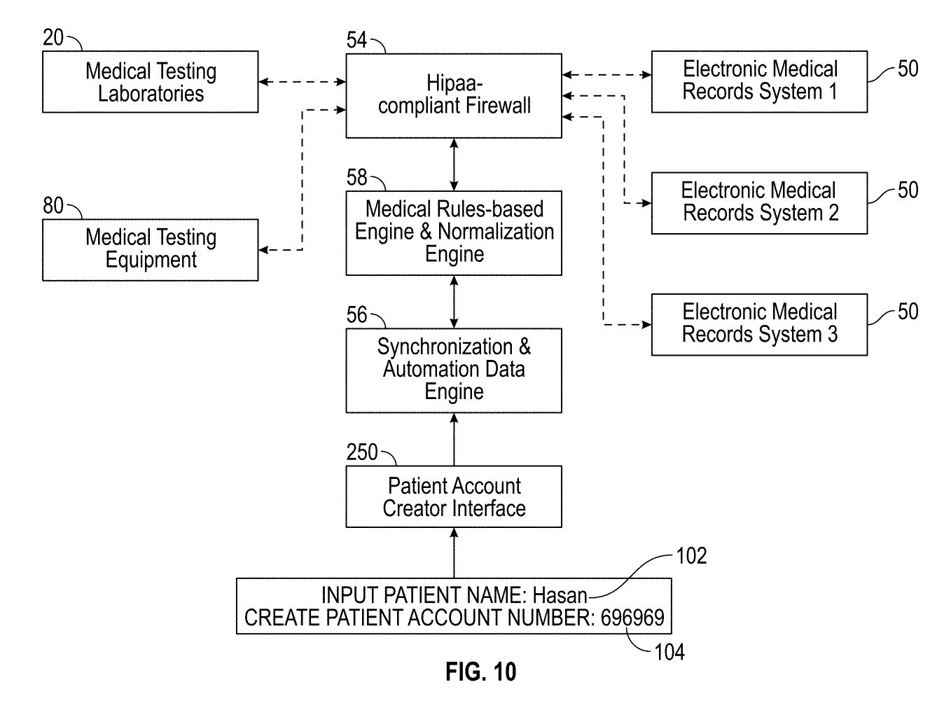

FIG. 10 is a simplified diagrammatic view of an example account creation for a new electronic patient medical record uploaded to the network by data input at a peripheral device accessing the network.

### DETAILED DESCRIPTION OF THE DRAWINGS

With reference now to the drawings, and in particular FIGS. 1 through 10 thereof, example of the instant automated medical test data report, tracking, and patient matching system employing the principles and concepts of the present automated medical test data report, tracking, and patient matching system and generally designated by the reference number 10 will be described.

Referring to FIGS. 1 through 10 a preferred embodiment of the automated medical test data report, tracking, and patient matching system 10 is illustrated.

The present automated medical test data report, tracking, and patient matching system 10 has been devised to automate medical test results reporting to effect update of a patient medical record 100 made accessible by a unique patient account. Medical tests, many of which are repetitive to establish baselines and trends, are therefore interfaced to transmit test data from the test location via secure Internet protocol for secure storage in a database housed on at least one central server 50. Test results are displayable as part of an electronic patient medical record 100 when an end user accesses a patient account and displays the patient medical record 100 (see for example FIG. 3). A synchronization engine 70 populates the medical record 100 by communication protocol with at least one database wherein test data is secure.

All instances of a patient medical record 100 in use will therefore display up-to-date information by action of the synchronization engine. Patient accounts 100 are determinable by unique patient identification data, such as a unique patient account number, for example, or unique biometric data, which enables retrieval of associated data.

FIG. 1 details transmission of data between a remote host 20 and a central server 50 whereat a database of electronic patient medical records 100 is housed. The remote host 20 in this instance is taken to include testing apparatuses able to generate results data 22 and transmit over network. Alternately, the remote host 20 in this instance may be a computer terminal for data entry of test results.

When ready to begin transmission of results data 22, the remote host 20 sends a query prompt 24 to the central server 50. Upon receipt of the prompt 24 the central server 50 sends a receipt 26 to establish connection with the remote host 20. As shown in FIG. 1, connection may be established via secure shell (“SSH”) protocol or other secure tunnel whereby encrypted transmissions are anonymized. Once the remote host 20 receives the receipt 26 transmitted from the central server 50, the remote host 20 sends a public key 28 to the central server 50. In response the central server 50 sends a public key 30 to the remote host 20. The remote host then generates a sequencing order 33 to sequence data into data packets 70 to be transmitted over network (see FIG. 2). The sequencing order 33 may be a positional function whereby data are inserted at specific sequences into a data stream (see FIG. 2).

The remote host 20 then transmits the sequencing order 33 to the central server 50 as an encrypted transmission locked with the central server's public key 30. Matching of the public key 30 with the central server's private key 32 enables extraction of the sequencing order 33 which is cached to memory.

The central server 50 sends back to the remote host 20 another receipt 34 locked with the remote host's public key 28. The remote host 20 matches the receipt 34 with the remote host's private key 36 to authenticate receipt of the sequencing order 33. The remote host 20 then transmits the first data packet 70 with data merged into a data stream according to the function of the sequencing order 33 generated by the remote host 20. The encoded and sequenced transmission is then received by the central server 50 wherein the cached sequencing order 33 enables extraction of data by reverse running of the function, whereby bits are extractable from selected points in the data stream sequence and data is thereby reassembled. Patient identification data 102, and other pertinent data, is thereby extractable from the data stream and data is thereby routable to populate or update the electronic patient medical record 100 stored to memory in the central server 50. After receipt of the packet 70 is complete, the sequencing order 33 is uncached and deleted from the central server 50. Issuance of a receipt 36 from the central server to the remote host signals completion of the transmission whereby the process may be repeated for the ensuing packet of data. The process is repeated until the final data packet is transmitted.

FIG. 2 illustrates a simplified, diagrammatic example of sequencing the data into a merged data stream 72. The remote host 20 here is the origin of data transmitted to the network. In this example embodiment the patient account number 104, the principal means of patient identification by which the data will be routed to the correct electronic patient medical record 100, is about to be transmitted as identifier with results data 22 generated or input at the remote host 20. The remote host 22 generates a randomized incidence of the sequencing order 33, exemplified here as a function that interpolates a data bit in every third place in a numerical sequence comprising a data stream 72. The test result data 22 is thus merged with the patient identification data 102 according to the positions dictated by the randomized sequencing order 33. Metadata (sort codes and sorting tags, for example) 40 pertaining to the test type, and directing which final directory the data stream 72 is to lodge, is appended to the transmission. The data packet 22 is then transmitted cryptographically to the central server 50 (see FIG. 1). Matching of the central server's 50 public and private key 30, 32 enable receipt of the data packet 22 and the reverse convolution of the data stream 72 according to the sequencing order enables extraction of the relevant ordering of data 22 to reassemble the data, route the data to its correct destination correlated to a unique patient identity 104 and the particular directories 500 usable to populate fields in a corresponding patient medical record 100.

FIG. 3 shows a simplified, diagrammatic view of display of the electronic patient medical record 100 upon a peripheral device 250 authorized to access the central server 50. The peripheral device 250 accesses the central server 50 and displays the medical record 100 but does not store the medical record 100 to local memory. The electronic patient record 100 is only displayable over network. Read-write privileges are thus controlled. In some instances a user may read-write to the medical record 100, and in such instances the peripheral device 250—if so authorized—operates in like manner as the remote host 20 examples illustrated in FIGS. 1 and 2 respectively.

FIG. 4 illustrates fragmentation of the data stream by addition of sort codes to the data stream whereby fragmented packets of data 76 are routable to specific directories and/or partitions 500 connected in network. Re-assembly of the fragmented data stream is necessary to recreate the electronic patient medical record 100 to which the data stream properly belongs. Each of the fragmented packets of data 76, as well as the data stream en masse, may be transmitted as a separate file type to which default security protocols may be associated.

FIG. 5 illustrates a diagrammatic view of an interconnected network of central servers 50 connected with remote hosts 20 via a HIPPA-compliant firewall 54 for display of data on a peripheral device 250. Data flowing between a point of test procedure 80, a remote host 20, and each of the central servers 50, flows through a synchronization engine 56 to maintain priority and integrity of data processed through the system whereby updates to a particular electronic patient medical record 100 are coordinated for update and delivery of data. In this diagrammatic view, the medical rules-based engine and normalization engine 58 is the determinative step routing data to a particular central server 50. Data streams 72 may thus be segregated, duplicated, or partitioned, and packets 70 may be delivered to various remotely connected databases hosted remotely relative one another, whereby re-assembly of the electronic patient medical record 100 pulls data from multiple points of presence over network further rendering safety and integrity of the data stored. Compromise of any one of the central servers 50 connected over network, therefore, only admits access to part of the data stream 72. Thus a complete medical health record 100 may not be attainable absent access to all servers 50 whereon portions of a data stream 72 are stored. Further, intercept of any one of the packets 70 en route to re-assemble the data stream 72 for view at a peripheral device 250 likewise will not reveal the complete data stream 72.

Referring to FIG. 6, an example diagrammatic view of initiation of a test results data 22 from a particular point of test procedure 80 is illustrated. Medical test data 22 is generated at point of test procedure 80, and may be automated through a networked testing apparatus or effected by manual entry at the test location. For example, as shown in FIG. 5, blood work performed on a Beckman Coulter Access 2 immunoassay analyzer may generate data communicable to the synchronization engine to update a plurality of medical records associated with the unique patient account. The apparatus may also automate discovery of the relevant patient account by biometric analysis of the individual patient subject to the test (by determining DNA sequences, for example) or by interface with appointment scheduling whereby a patient known to be submitting to the test is associated with the test data. Such automated generation of patient identity may be subject to approval by a practitioner.

FIG. 7 illustrates an example view of a medical record 100 retrievable through each of a plurality of record storage media 60. Each of the plurality of storage media is a central server 50. The patient identification data 102 herein exemplified to effect retrieval of associated data is a unique account number 104. The medical record 100 accessed under the unique account number 104 is interactive, and display of various relevant data may be effected by means of a graphical user interface.

FIGS. 8 and 9 illustrate an example database of relevant numerical data interfaced with the synchronization engine, wherein new data is uploaded to the database when medical test data is received through the synchronization engine and whereby stored data is accessible to populate patient medical records 100. In this example, unique patient test data 22 are storable by association with a unique patient account number 104. Retrieval of said test data 22 is thereby effective by interface of the account number 104.

Each transmission of data to and from storage media, the synchronization engine, and medical records displayed on local or peripheral devices, may effect transfer by sequencing a patient identification data 102 into a relevant data transmission whereby said data is routable to a particular patient account and corresponding directory within the associated patient medical record 100 and/or database. Thus a particular data transmission is routable to a particular location (see also FIG. 4).

FIG. 10 illustrates a simplified diagrammatic view of uploading a new electronic patient medical record to the network by end user input at a peripheral device 250. Data may thus flow from authorized peripheral devices to initiate creation of an electronic patient health record for coordination and update through the system.

Medical records, updatable by medical test data automation, further enables manipulation of said data in display, whereby graphical representations of data may be automated. Thus, a medical record may show numerical data or populate graphs to show a changing metric relative another metric, such as T cell count over time, for example, or blood sugar level. Further, embedded medical devices (such as pacemakers, for example), and/or peripheral devices associated with a unique patient account and generable of specific medical data may be networked to communicate at determinable intervals with the present system, whereby real time tracking of patient biometrics may be enabled by the present system.

What is claimed is:

1. A method for automated medical test data report, tracking, and patient matching system devised to enable secure transmittal of medical test results data over network between a hosting computing apparatus and a receiving computing apparatus, said method comprising the steps of:
initiating a communication request from a hosting computing apparatus and transmitting the communication request to a receiving computing apparatus;
returning a receipt prompt from the receiving computing apparatus to the hosting computing apparatus;
transmitting a first public key from the hosting computing apparatus to the receiving computing apparatus;
transmitting a second public key from the receiving apparatus to the hosting computing apparatus;
generating a randomized sequencing order at the hosting computing apparatus following receipt of the second public key;
transmitting the sequencing order from the hosting computing apparatus to the receiving computing apparatus as part of an encrypted transmission locked by the second public key, said encrypted transmission decodable by matching the second public key with an equivalent private key securely hosted on the receiving computing apparatus;
extracting the sequencing order sent from the hosting computing apparatus and caching said sequencing order to temporary memory;
transmitting a data receipt to the hosting computing apparatus from the receiving computing apparatus, said data receipt locked by the first public key for match with a private key securely stored upon the hosting computing apparatus;
securely transmitting a first packet of medical data encoded with the patient identification number embedded to the transmission according to sequencing as dictated by the sequencing order, said first packet of medical data encoded and locked by the second public key for match with the private key stored at the receiving computing apparatus;
returning a data packet receipt to the hosting computer upon receipt of the first packet of medical data;
deleting the sequencing order from the hosting computing apparatus after receipt of the data packet receipt;
re-sequencing the patient identification number from the first packet of medical data by action of the sequencing order;
routing the medical data to a patient medical record matched to the patient identification number to effect update of medical record;
deleting the sequencing order from the receiving computing apparatus; and
repeating the above steps for as many packets of medical data are required until transmission is complete.

2. The method for automated medical test data report, tracking, and patient matching system devised to enable secure transmittal of medical test results data over network between a hosting computing apparatus and a receiving computing apparatus of claim 1 wherein the sequencing order comprises a randomized function controlling position of bits in a data packet to merge data by interposition of bits into a sequence whereby data is extractable according to the same sequencing order.

3. The method for automated medical test data report, tracking, and patient matching system devised to enable secure transmittal of medical test results data over network between a hosting computing apparatus and a receiving computing apparatus of claim 2 wherein the data is accessible at a central server to an authorized peripheral, said authorized peripheral not permitted to host the data locally.

4. The method for automated medical test data report, tracking, and patient matching system devised to enable secure transmittal of medical test results data over network between a hosting computing apparatus and a receiving computing apparatus of claim 3 wherein writing of data hosted on the central server to local memory is not permissible.

5. The method for automated medical test data report, tracking, and patient matching system devised to enable secure transmittal of medical test results data over network between a hosting computing apparatus and a receiving computing apparatus of claim 4 wherein sort codes are attachable to the data packets to control delivery of each data packet to a particular directory or partition accessible over network.

6. A method for automated medical test data report, tracking, and patient matching system devised to enable secure transmittal of medical test results data over network between a hosting computing apparatus and at least one receiving computing apparatus, said method comprising the steps of:
initiating a communication request from a hosting computing apparatus and transmitting the communication request to at least one receiving computing apparatus;
returning a receipt prompt from each at least one receiving computing apparatus to the hosting computing apparatus;
transmitting a first public key from the hosting computing apparatus to each at least one receiving computing apparatus;
transmitting a separate public key from each at least one receiving apparatus to the hosting computing apparatus;
generating a randomized sequencing order at the hosting computing apparatus following receipt of the separate public key from each at least one receiving computing apparatus;
transmitting the sequencing order from the hosting computing apparatus to each of the at least one receiving computing apparatus as part of an encrypted transmission locked by the separate public key associated with each of the at least one receiving computing apparatus, said encrypted transmission decodable by matching the separate public key with an equivalent private key securely hosted on each of the at least one receiving computing apparatus;
extracting the sequencing order sent from the hosting computing apparatus and caching said sequencing order to temporary memory in each of the at least one receiving computing apparatus;
transmitting a data receipt to the hosting computing apparatus from each of the at least one receiving computing apparatus, said data receipt locked by the first public key for match with a private key securely stored upon the hosting computing apparatus;
sequencing a patient identification number into a medical data packet as dictated by the sequencing order to create a merged data stream;
fragmenting the merged data stream into fragmented data packets delimited by insertion of a plurality of sort codes;
transmitting each fragmented data packet over network to a separate and unique destination location as directed by each of the plurality of the sort code;
returning a data packet receipt to the hosting computer upon receipt of one of the fragmented data packets at one of the at least one receiving computer apparatus;
deleting the sequencing order from the hosting computing apparatus after receipt of the data packet receipt from each of the at least one receiving computing apparatus;
re-sequencing the patient identification number from each packet of medical data by action of the sequencing order;
routing the medical data to a patient medical record matched to the patient identification number to effect update of the medical record;
deleting the sequencing order from the at least one receiving computing apparatus; and
repeating the above steps for as many packets of medical data are required until transmission is complete.
